(19) United States
(12) Patent Application Publication
(10) Pub. No.: US 2026/0128341 A1
(43) Pub. Date: May 7, 2026

(54) REINFORCED ION-CONDUCTING MEMBRANE

(71) Applicant: JOHNSON MATTHEY HYDROGEN TECHNOLOGIES LIMITED, London (GB)

(72) Inventors: Apoorva AMBARKAR, Reading (GB); Silvain BUCHE, Reading (GB)

(21) Appl. No.: 19/117,832

(22) PCT Filed: Nov. 10, 2023
(86) PCT No.: PCT/GB2023/052946

§ 371 Date: Apr. 2, 2025

(30) Foreign Application Priority Data
Nov. 11, 2022 (GB) 2216864.5

(51) Int. Cl. H01M 8/106; C08J 3/24; C08J 5/22; C25B 13/02; C25B 13/08; D04H 1/4326; D04H 1/4382; D04H 1/56; D04H 1/728; D06M 15/356; D06M 101/30; H01M 8/10; H01M 8/1062; H01M 8/1067; H01M 8/1081

(52) U.S. Cl. CPC H01M 8/106; C08J 3/24; C08J 5/2237; C25B 13/02; C25B 13/08; D04H 1/4326; D04H 1/43838; D04H 1/56; D04H 1/728; D06M 15/3566; H01M 8/1062; H01M 8/1067; H01M 8/1081; C08J 2327/00; C08J 2365/00; D06M 2101/30; D06M 2200/00; D10B 2331/14; D10B 2401/063; D10B 2505/00; H01M 2008/1095

(57) ABSTRACT

Reinforced ion-conducting membrane According to the present invention there is provided a reinforced ion-conducting membrane comprising: an ion-conducting polymer; and a porous mat of nanofibres. The porous mat of nanofibres is impregnated with the ion-conducting polymer. The nanofibres comprise a cross-linked polymer, wherein the cross-linked polymer is ionically non-conductive. The cross-linked polymer comprises: a heterocyclic-based polymer backbone comprising basic functional groups, and linking chains linking at least two heterocyclic-based polymer backbones via linking groups. The porous mat of nanofibres has a tear index of at least 15 mN m²/g.

### FIELD OF THE INVENTION

This invention relates to a reinforced ion-conducting membrane, such as a reinforced electrolyte membrane. In particular, this invention relates to a reinforced proton exchange membrane, and methods of manufacturing the same. The reinforced ion-conducting membrane can be suitable for use in electrochemical devices such as fuel cells and/or electrolysers.

### BACKGROUND OF THE INVENTION

A fuel cell is an electrochemical cell comprising two electrodes separated by an electrolyte. A fuel, e.g. hydrogen, an alcohol such as methanol or ethanol, or formic acid, is supplied to the anode and an oxidant, e.g. oxygen or air, is supplied to the cathode. Electrochemical reactions occur at the electrodes, and the chemical energy of the fuel and the oxidant is converted to electrical energy and heat. Electrocatalysts are used to promote the electrochemical oxidation of the fuel at the anode and the electrochemical reduction of oxygen at the cathode.

Fuel cells are usually classified according to the nature of the electrolyte employed. Often the electrolyte is a solid polymeric membrane, in which the membrane is electronically insulating but ionically conducting. In the proton exchange membrane fuel cell (PEMFC) the membrane is proton conducting, and protons, produced at the anode, are transported across the membrane to the cathode, where they combine with oxygen to form water.

An electrolyser is an electrochemical device for electrolysing water to produce high purity hydrogen and oxygen. Electrolysers can operate in both alkaline and acidic systems. Those electrolysers that employ a solid proton-conducting polymer electrolyte membrane, or proton exchange membrane (PEM), are known as proton exchange membrane water electrolysers (PEMWEs). Those electrolysers that utilise a solid anion-conducting polymer electrolyte membrane, or anion exchange membrane (AEM), are known as anion exchange membrane water electrolysers (AEMWEs).

A principal component of the fuel cell or water electrolyser is the membrane electrode assembly (MEA). The MEA is typically composed of five layers. The central layer is the polymer ion-conducting membrane. On either side of the ion-conducting membrane there is an electrocatalyst layer, containing an electrocatalyst designed for the specific electrolytic reaction. Finally, adjacent to each electrocatalyst layer there is a gas diffusion layer, and/or a porous transport layer, which is porous and electrically conducting and allows the reactants to reach the electrocatalyst layer and conduct the electric current that is generated by the electrochemical reactions.

Conventional ion-conducting membranes used in PEMFCs or PEMWEs are generally formed from sulphonated fully-fluorinated polymeric materials (often generically referred to as perfluorinated sulphonic acid (PFSA) ionomers). As an alternative to PFSA type ionomers, it is possible to use ion-conducting membranes based on partially fluorinated or non-fluorinated hydrocarbon sulphonated or phosphonated polymers. Recent developments in fuel cells and electrolysers require membranes to be thinner due to the advantages obtained (improved ionic conductivity, improved water transport etc) and thus, in order to provide the mechanical properties required to increase resistance to premature failure, a reinforcement, typically expanded polytetrafluoroethylene (ePTFE), is embedded within the membrane.

Although such reinforced membranes often have lower proton conductivity when compared to an unreinforced membrane of the same thickness, the improvement in mechanical properties has enabled thinner membranes of lower electrical resistance to be used.

Other types of reinforcement have also been proposed, for example as disclosed in WO2011/149732 and WO2016/020668.

Li and Liu; J. Mater. Chem. A., 2013, 1, 1171 discloses polyelectrolyte composite membranes of polybenzimidazole and crosslinked polybenzimidazole-polybenzoxazine electrospun nanofibres for proton exchange membrane fuel cells. The membranes were doped with 85% phosphoric acid, which rendered the polymers of the composite membrane proton conductive (including the polymer of the nanofibres). It is desirable to develop reinforced ion-conducting membranes which have improved mechanical properties.

### SUMMARY OF THE INVENTION

Although reinforced membranes such as those hereinbefore described have allowed thinner membranes to be used whilst maintaining mechanical strength, deficiencies still exist. In particular, limitations are seen in practical operation in which the conditions of humidity can vary quite significantly over short periods of time from relatively high levels (such as on start up from cold conditions) to quite dry levels (operation at maximum rated power density) where the membrane can degrade to a higher level than acceptable. In accelerated stress tests designed to mimic and accelerate this operation, a wet/dry cycling accelerated stress testing induces swelling/de-swelling of the membrane such that these membrane degradation effects can be more rapidly observed.

It is an object of the present invention to provide an improved reinforced ion-conducting membrane, suitably for use in electrochemical devices, such as fuel cells and electrolysers, and in particular having improved properties for large-scale manufacturing.

Accordingly, in a first aspect of the invention there is provided a reinforced ion-conducting membrane comprising:
an ion-conducting polymer; and
a porous mat of nanofibres, which is impregnated with the ion-conducting polymer;
wherein the nanofibres comprise a cross-linked polymer, wherein the cross-linked polymer is ionically non-conductive and comprises:
heterocyclic-based polymer backbones comprising basic functional groups, and
linking chains linking at least two of the heterocyclic-based polymer backbones via linking groups,
wherein the porous mat of nanofibres has a tear index of at least 15 mN m²/g.

The porous mat of nanofibres (also sometimes referred to as a “nanofibre mat”) provides mechanical reinforcement to the ion-conducting membrane. The porous mat of nanofibres can be in the form of a non-woven fabric material.

The term tear index (mN m²/g) as used herein refers to the maximum tear strength (mN) divided by the basis weight (g/m²). The tear strength can be measured in accordance with ASTM D1938.

In a second aspect there is provided a reinforced ion-conducting membrane comprising:
an ion-conducting polymer; and
a porous mat of nanofibres, which is impregnated with the ion-conducting polymer;
wherein the nanofibres comprise a cross-linked polymer, wherein the cross-linked polymer is ionically non-conductive and comprises:
heterocyclic-based polymer backbones comprising basic functional groups, and
linking chains linking at least two of the heterocyclic-based polymer backbones via linking groups, wherein each linking group (A) is independently selected from the group consisting of:

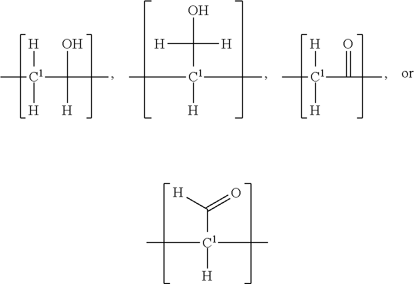

wherein C¹ is chemically bonded to a heterocyclic-based polymer backbone.

In a further aspect there is provided reinforced ion-conducting membrane comprising:
an ion-conducting polymer; and
a porous mat of nanofibres, which is impregnated with the ion-conducting polymer;
wherein the nanofibres comprise a cross-linked polymer, wherein the cross-linked polymer is ionically non-conductive and comprises:
heterocyclic-based polymer backbones comprising basic functional groups, and
linking chains linking at least two of the heterocyclic-based polymer backbones via linking groups;
wherein the porous mat has a mean average thickness of 10 μm or less and the reinforced ion-conducting membrane has a secant modulus of elasticity at 8% strain of at least 30 MPa when measured in a machine direction at a temperature of 80° C. and 90% relative humidity (RH), and a secant modulus of elasticity at 8% strain of at least 30 MPa when measured in a transverse direction at a temperature of 80° C. and 90% RH, wherein the machine direction and the transverse direction are perpendicular.

In a third aspect, there is provided a method of producing a reinforced ion-conducting membrane, the method comprising the steps of:
providing a substrate;
providing a formulation for electrospinning, the formulation comprising a solvent, a cross-linker and a heterocyclic-based polymer comprising basic functional groups,
electrospinning the formulation onto the substrate to form a porous mat of nanofibres;
treating the porous mat to cause the heterocyclic-based polymer and the cross-linker to react thereby forming a cross-linked polymer comprising a heterocyclic-based polymer backbone comprising basic functional groups, and linking chains linking at least two of the heterocyclic-based polymer backbones via linking groups; and
impregnating the porous mat with an ion-conducting polymer.

In a fourth aspect, there is provided a method of producing a reinforced ion-conducting membrane, the method comprising the steps of:
providing a substrate;
providing a first formulation for electrospinning, the first formulation comprising a solvent, and a heterocyclic-based polymer comprising basic functional groups,
electrospinning the first formulation onto the substrate to form a porous mat of nanofibres;
providing a second formulation comprising a cross-linker;
impregnating the porous mat with the second formulation, and then treating the porous mat to cause the heterocyclic-based polymer and the cross-linker to react thereby forming a cross-linked polymer comprising a heterocyclic-based polymer backbone comprising basic functional groups, and linking chains linking at least two of the heterocyclic-based polymer backbones via linking groups; and
impregnating the porous mat with an ion-conducting polymer.

In a fifth aspect, there is provided a cross-linkable porous mat of nanofibres, the nanofibres comprising:
a heterocyclic-based polymer comprising basic functional groups, wherein the heterocyclic-based polymer is ionically non-conductive; and
a cross-linker preferably comprising at least two terminal epoxide groups.

In a sixth aspect, there is provided a reinforcing component for reinforcing an ion-conducting membrane, the reinforcing component comprising:
a porous mat of nanofibres, the nanofibres comprising a cross-linked polymer, wherein the cross-linked polymer is ionically non-conductive and comprises:
a heterocyclic-based polymer backbone comprising basic functional groups, and
linking chains linking at least two of the heterocyclic-based polymer backbones via linking groups, wherein the porous mat of nanofibres has a tear index of at least 15 mN m²/g.

### BRIEF DESCRIPTION OF THE DRAWINGS

FIG. 1 is a schematic representation of an ion-conducting membrane of the invention;

FIG. 2 is a schematic representation of an exemplary process of the invention;

FIG. 3 is a schematic representation of an exemplary process of the invention;

FIG. 4 is a SEM image of a porous mat of nanofibres according to an embodiment of the invention;

FIGS. 5 to 8 are plots of force (N) as a function of extension (mm);

FIG. 9 is a scheme of an exemplary reaction between a PBI and a cross-linker;

FIG. 10 is a plot of stress vs. strain for reinforced ion-conducting membranes measured in a machine direction (MD) and in a transverse direction (TD) at 80° C. and 90% RH; and

FIG. 11 is a plot of OCV response to removal of differential pressure as a function of stress cycle number.

### DETAILED DESCRIPTION OF THE INVENTION

Preferred and/or optional features of the invention will now be set out. Any aspect of the invention may be combined with any other aspect of the invention, unless the context demands otherwise. Any of the preferred or optional features of any aspect may be combined, singly or in combination, with any aspect of the invention, unless the context demands otherwise.

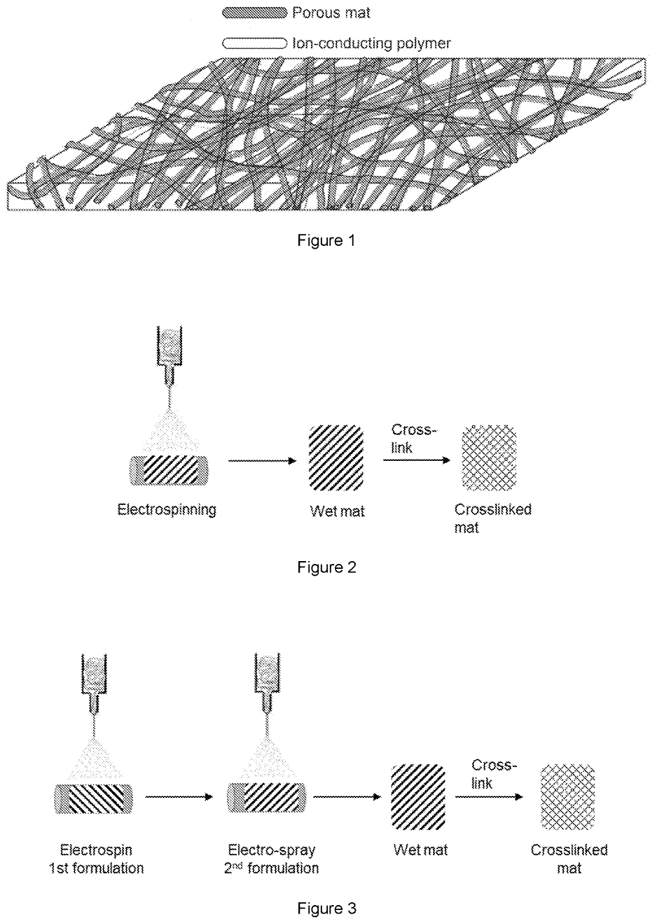

The invention provides a reinforced ion-conducting membrane, such as an electrolyte membrane, comprising a porous mat of nanofibres, the porous mat being impregnated with an ion-conducting polymer. Preferably, the porous mat is essentially fully impregnated with the ion-conducting polymer. FIG. 1 shows a schematic representation of an ion-conducting membrane of the invention. Preferably, the reinforced ion-conducting membrane is a reinforced proton-conducting membrane.

The porous mat provides mechanical reinforcement to the ion-conducting membrane. The porous mat is suitably formed from entangled nanofibres. The nanofibres are ionically non-conductive. For example, the nanofibres are suitably devoid of sulphonic acid groups and/or phosphoric acid groups. The ion-conducting membrane is suitably devoid of phosphoric acid. The nanofibres comprise a cross-linked polymer, which is ionically non-conductive. The nanofibres comprise discrete nanofibres that are entwined. For example, the nanofibres can cross each other or be twisted with other nanofibres or itself. The porous mat of nanofibres can be in the form of a non-woven fabric material. Suitably, the nanofibres have a substantially random orientation in the plane of the reinforced ion-conducting membrane (i.e. xy plane).

The porous mat can have a tear index of at least 15 mN m²/g, preferably at least 20 mN m²/g, preferably at least 25 mN m²/g, preferably at least 30 mN m²/g, preferably at least 35 mN m²/g, preferably at least 40 mN m²/g, preferably at least 45 mN m²/g. The tear index is the quotient of the maximum tear strength (mN) and the basis weight (g/m²).

The nanofibres suitably have a diameter of 50-700 nm, suitably 200-600 nm and preferably 250-550 nm.

The length of the nanofibres is not material to the invention, but each nanofibre should be sufficiently long (for example several millimetres or centimetres) to be entangled, either with one or more other nanofibres or with itself.

The nanofibres are suitably spun nanofibres, i.e. the nanofibres are formed using a spinning technique. Examples of suitable spinning techniques include, but are not limited to, electrospinning and force spinning.

The cross-linked polymer comprises a heterocyclic-based polymer backbone, and linking chains. The linking chains link at least two of the heterocyclic-based polymer backbones via linking groups. Suitably, the cross-linked polymer consists essentially of (or consists of) the heterocyclic-based polymer backbone, the linking chains and optionally a second polymer, wherein the second polymer is ionically non-conductive.

The heterocyclic-based polymer backbone comprises basic functional groups, such as nitrogen-containing basic functional groups. The nitrogen-containing basic functional groups can be nitrogen with a lone pair. The heterocyclic-based polymer backbone further comprises linking sites which are chemically bonded (e.g. covalently bonded) to the linking groups. The linking site can be a heteroatom, such as N. The heteroatom can be part of a heterocyclic ring.

Suitably, each linking group (A) is independently selected from the group consisting of:

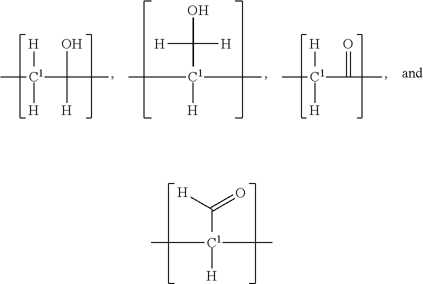

wherein C¹ is chemically bonded to a heterocyclic-based polymer backbone. For example, C¹ can be chemically bonded to a heteroatom, such as N, on the heterocyclic-based polymer backbone. Preferably, the linking group (A) is —[C¹H₂CH(OH)]—. The linking groups A are derivable from cross-linkers comprising terminal epoxide function groups, such as terminal glycidyl ether groups.

Suitably, the cross-linked polymer is insoluble in organic solvent, and in particular the cross-linked polymer is insoluble in N-methylpyrrolidone (NMP), dimethylformamide (DMF), dimethylacetamide (DMAc) or dimethylsulphoxide (DMSO), suitably DMAc or DMSO and preferably DMAc.

The heterocyclic-based polymer backbone can be derived from basic heterocyclic-based polymers, including polybenzimidazoles, poly(pyridine)s, poly(pyrimidine)s, polybenzthiazoles, polyoxadiazoles, polyquinolines, polyquinoxalines, polythiadiazoles, polytriazoles, polyoxazoles, polybenzoxazoles, polythiazoles, polypyrazoles, and derivatives thereof. Suitably, the heterocyclic-based polymer backbone is derived from a functionalised polyazole or a zwitterionic polyazole, such as a polybenzimidazole, polytriazole, polythiazole and polydithiazole and their derivatives; most suitably a polybenzimidazole.

The cross-linked polymer can comprise heterocyclic-based polymer backbones of the same or different types. For example, the cross-linked polymer can comprise heterocyclic-based polymer backbones of a first type and heterocyclic-based polymer backbones of a second type, wherein the first and second types of heterocyclic-based polymer backbones are different in the sense that they have a different chemical structure/composition. The linking chains can link heterocyclic-based polymer backbones of the same or different types, for example, the linking chains can link a heterocyclic-based polymer backbone of the first type with a heterocyclic-based polymer backbone of the second type.

The cross-linked polymer is cross-linked by linking chains. Each linking chain links at least two of the heterocyclic-based polymer backbones via at least two linking groups. That is, one heterocyclic-based polymer backbone is bonded to another heterocyclic-based polymer backbone via at least two linking groups and a linking chain. Cross-linking improves the mechanical and tensile properties of the porous mat of nanofibres and thereby of the reinforced ion-conducting membrane.

The linking groups suitably comprise a carbon C¹ which is chemically bonded (e.g. covalently bonded) to a heterocyclic-based polymer backbone, for example at a linking site on the heterocyclic-based polymer backbone. The linking chains have a different chemical structure to the heterocyclic-based polymer backbone.

The linking chains can be non-polymeric or polymeric, preferably non-polymeric. The linking chains can be aliphatic, aromatic or a combination of aliphatic and aromatic moieties. Preferably, the linking chains are aliphatic. Most preferably, the linking chains are non-polymeric and aliphatic. For example, the linking chains can be straight or branched aliphatic chains. Preferably, the linking chains comprise an alkyl chain and/or an alkoxy chain such as a glycol chain. “Alkyl” refers to a straight-chain or branched hydrocarbon group, optionally substituted with a heteroatom, such as O, N or S. The term “glycol chain” includes a chain comprising ethylene glycol, poly(ethylene glycol), propylene glycol and/or poly(propylene glycol) groups.

The linking chains can be devoid of cyclic groups, such as cyclic aromatic groups and cycloalkyl groups. Preferably, the linking chains are devoid of condensed rings, including carbocyclic condensed rings and heterocyclic condensed rings, such as benzoxazines.

The linking chains can have a chemical formula selected from the group consisting of:

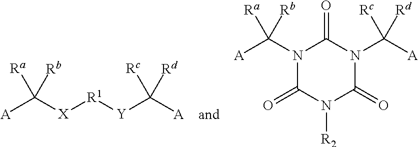

wherein:
A is the linking group, and each linking group A is independently selected from the group consisting of:

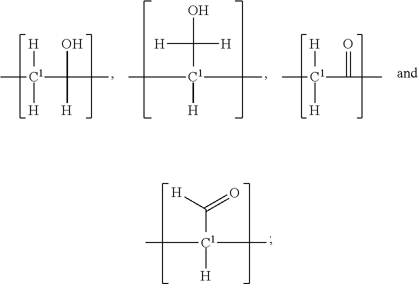

R¹ is selected from the group consisting of: an aliphatic C₁₋₁₅ alkyl chain, preferably C₁₋₁₀ alkyl chain and more preferably C₁₋₆ alkyl chain; an alkoxy chain, for example a glycol chain such as [CH₂CH₂O]ₘ, [CH₂CH(CH₃)O]ₘ, [CH₂CH₂CH₂O]ₘ; an aryloxy chain,

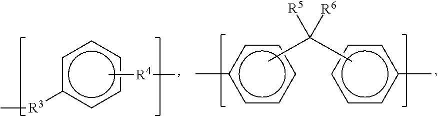

or a combination thereof;
X and Y are each independently selected from the group consisting of: O, [N(R⁷)], [OCH₂CH₂]ₙ, [OCH₂CH(CH₃)]ₙ, [O(CH₂)₃]ₙ and no atom;
R² and R⁷ are each independently selected from the group consisting of: H, C₁₋₅ alkyl chain, and [(CH₂)ₚA],
m and n are each independently in the range of and including 1 to 225,
R³ and R⁴ are each independently selected from an aliphatic C₁₋₅ alkyl chain; an alkoxy chain, for example a glycol chain; or no atom;
R^{a}, R^{b}, R^{c}, R^{d}, R⁵ and R⁶ are each independently selected from H, methyl, ethyl, n-propyl, iso-propyl, n-butyl, iso-butyl, sec-butyl, or tert-butyl; and
p is an integer in the range of and including 1 to 5.

Preferably, X and Y are each independently selected from the group: O and [N(R⁷)]. In some embodiments, X and Y are the same, for example X and Y can both be O. In other embodiments X and Y can both be [N(R⁷)].

Preferably, R² is H or [(CH₂)ₚA], and more preferably [(CH₂)ₚA].

Preferably, R³ and R⁴ are each independently an aliphatic C₁₋₃ alkyl chain or no atom.

Preferably, R⁵ and R⁶ are each independently selected from H or methyl. In some embodiments, R⁵ and R⁶ are both methyl. In other embodiments, R⁵ and R⁶ are both H.

Preferably, R⁷ is H or [(CH₂)ₚA], and more preferably [(CH₂)ₚA].

Preferably, R^{a}, R^{b}, R^{c}, R^{d} are each independently H or methyl, and most preferably H. For example, R^{a}, R^{b}, R^{c}, R^{d} can each be hydrogen.

Preferably, m and n are each independently in the range of and including 1 to 150, more preferably 1 to 130, more preferably 1 to 100 and still more preferably 1 to 50.

Preferably, p is an integer in the range of 1 to 3, preferably 1 or 2, and most preferably 1.

Preferably, the linking chains are selected from the group consisting of:

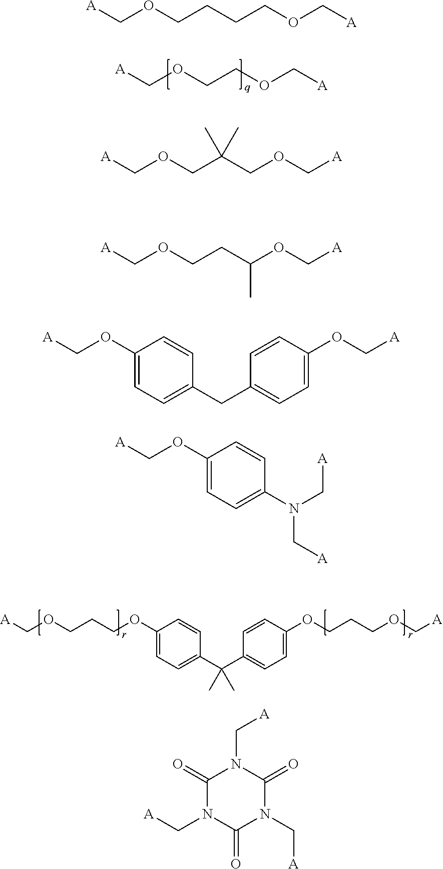

wherein q is in the range of and including 1 to 225, preferably about 130, and r is in the range of and including 1 to 225.

Preferably p is the range of and including 1 to 3. Preferably q is in the range of 1 to about 130. Preferably, r is in the range of and including 1 to 100.

The nanofibres can comprise the cross-linked polymer and a second polymer, for example as a blend or mixture. The second polymer is ionically non-conductive. The second polymer is different (i.e. in the sense that it has a different chemical composition) to the heterocyclic-based polymer from which the heterocyclic-based polymer backbones are derived. The second polymer can be a partially- or fully-fluorinated polymer or a hydrocarbon polymer. Preferably, the second polymer is a partially- or fully-fluorinated polymer. For example, the second polymer can be selected from the group consisting of: poly(vinylidene difluoride) (PVDF), polytetrafluoroethylene (PTFE), poly(vinylidene fluoride-co-hexafluoropropylene) (PVDF-HFP), polyimides (PI), polyetherimide (PEI), poly(aryl ether ketone) (PAEK), poly(aryl ether sulfone), poly(phenylene sulfide) (PPS), polyvinylpyrrolidone (PVP). Preferably, the second polymer is PVDF.

Providing a porous mat, which includes the cross-linked polymer and the second polymer, can further improve the mechanical and tensile properties of the porous mat, and hence the reinforced ion-conducting membrane.

The porous mat of the present invention can have a maximum tear strength of at least 38 mN, preferably at least 40 mN, preferably at least 50 mN, more preferably at least 60 mN, more preferably at least 70 mN, more preferably at least 80 mN, more preferably at least 90 mN, and more preferably at least 100 mN. The tear strength can be measured in accordance with ASTM D1938.

The porous mat of nanofibres can have an ultimate tensile strength of at least 25 MPa, preferably at least 30 MPa, when measured in a machine direction. The porous mat of nanofibres can have an ultimate tensile strength of at least 25 MPa, preferably at least 30 MPa, when measured in a transverse direction. Most preferably, the porous mat of nanofibres can have an ultimate tensile strength of at least 25 MPa, preferably at least 30 MPa, when measured in a machine direction; and the porous mat of nanofibres can have an ultimate tensile strength of at least 25 MPa, preferably at least 30 MPa, when measured in a transverse direction. The machine and transverse directions are perpendicular. The ratio of ultimate tensile strength of the porous mat of nanofibres measured in the machine direction to ultimate tensile strength of the porous mat of nanofibres measured in the transverse direction can be in a range of 0.5 to 2, preferably 0.6 to 1.5. The porous mat of nanofibres can have a strain at break of at least 5%, preferably at least 10%, at least 15% at least 20%, at least 25%, at least 30%, at least 35%, at least 40% at least 45% and preferably at least 50%, when measured in the machine direction. The porous mat of nanofibres can have a strain at break of at least 5%, preferably at least 10%, and more preferably at least 15%, when measured in the transverse direction. Preferably, the porous mat of nanofibres has a strain at break of at least 5%, preferably at least 10%, at least 15% at least 20%, at least 25%, at least 30%, at least 35%, at least 40% at least 45% and preferably at least 50%, when measured in the machine direction and at least 5%, preferably at least 10%, and more preferably at least 15%, when measured in the transverse direction. The ultimate tensile strength and strain at break can be determined by performing stress-strain tests on the porous mats. For example, a sample of the porous mat of nanofibres (80 mm×10 mm) can be prepared, with the longer dimension being parallel to the machine direction or transverse direction, when measuring the stress-strain relationship in the machine or transverse direction respectively. The sample can be clamped between the tensile-test fixtures of a universal mechanical tester and pulled at an extension rate of 20 mm/min, at room temperature (20° C.±3° C.) and a relative humidity (RH) of 30-50%, until the sample breaks. A stress-strain graph is plotted from which the ultimate tensile strength and strain at break can be derived. The thickness of the porous mat required for the stress-strain test can be measured by cross-sectional imaging using a Scanning Electron Microscope (SEM) (e.g. JEOL JSM-IT300LV SEM) after resin embedding and using the SEM integrated ruler to measure the edge-to-edge thickness of the mats.

The reinforced ion-conducting membrane can have a secant modulus of elasticity (also referred to herein as “secant modulus”) (at 8% strain) measured in the machine direction of at least 30 MPa, and preferably at least 35 MPa, more preferably at least 40 MPa, more preferably at least 45 MPa, and most preferably at least 50 MPa, for example, when measured at 80° C., 90% RH, and at a stress ramp of 0.2 MPa/min. The reinforced ion-conducting membrane can have a secant modulus (at 8% strain) measured in the transverse direction of at least 30 MPa, preferably at least 35 MPa, more preferably at least 40 MPa, more preferably at least 45 MPa, and most preferably at least 50 MPa, for example, when measured at 80° C., 90% RH, and at a stress ramp of 0.2 MPa/min. The reinforced ion-conducing membrane can have a ratio of secant modulus of elasticity (at 8% strain) measured in the machine direction to secant modulus of elasticity (at 8% strain) measured in the transverse direction in a range of 0.75 to 1.4, preferably in a range of 0.80 to 1.3, and more preferably 0.90 to 1.2, and most preferably about 1.0. A value of this ratio which is close to 1.0 is indicative of an isotropic reinforced ion-conducting membrane. The secant modulus of elasticity can be measured by sampling a rectangular strip of the reinforced ion-conducting membrane with dimensions of 60 mm×6 mm, with the longer dimension being parallel to either the machine direction or the transverse direction of the reinforce ion-conducting membrane, when measuring the secant modulus in the machine or transverse direction respectively. The thickness of this sample was measured using a low force high precision gauge instrument (e.g. a Mitutoyo VL-50-B micrometer), in which a motorised spindle is used to take measurement readings with a measuring force of 0.01 N and at a temperature of 20° C.±3° C., and a relative humidity (RH) of 30-50%. The sample was installed into a dynamic mechanical analyser (DMA) (e.g. a Q800 available from TA Instruments) equipped with a relative humidity controlling chamber and tensile (film) clamps, which can be set approximately 16 mm apart and tightened with 3 in lbs (˜0.34 N·m) of torque. Using automation of the DMA the sample length can be determined and an experiment can be performed comprising of the following parameters/steps: pre-force 0.001 N; measure length; set relative humidity to 90% and temperature to 80° C.; hold for 120 mins; measure length; ramp stress at 0.2 MPa/min. Where ‘measure length’ sets the length of the sample to 0% strain. Due to the peak gradient of the stress/strain relationship not occurring at 0% strain at these conditions, a secant modulus is used. The stress at 8% strain is divided by 0.08 to obtain the secant modulus value. A value of 8% strain is chosen because this is typically the upper extremity of the in-plane swell of a reinforced membrane in fuel cell or electrolyser operation.

The porous mat suitably has an open structure and porosity in the range of 70-98%, suitably 80-95%, suitably 85-95% and preferably 90-95%. The porosity is determined from the ratio of the volumetric mass of the porous mat, determined from its geometrical dimensions and its mass, to the known density of the polymer.

The porous mat suitably has an average basis weight in the range 1 g/m² to 7 g/m², suitably in the range 1.5 g/m² to 4 g/m².

The porous mat in the electrolyte membrane suitably has a maximum thickness of 50 μm, 30 μm, suitably 25 μm and preferably 20 μm. The porous mat in the electrolyte membrane suitably has a minimum thickness of about 2 μm, preferably 3 μm, and suitably 5 μm. The porous mat in the electrolyte membrane can have a thickness in a range comprising any combination of the aforementioned upper and lower limits. Preferably, the porous mat in the electrolyte membrane has an average thickness of 10 μm or less, more preferably 8.0 μm or less, and more preferably still 7.0 μm or less, or suitably 5 μm or less. Preferably, the porous mat in the electrolyte membrane has an average thickness of at least 2 μm, preferably at least 3 μm, and more preferably at least 5 μm. The average thickness of the porous mat in the electrolyte membrane can be a range comprising any combination of the aforementioned upper and lower limits. The thickness of the porous mat was measured by cross-sectional imaging using a Scanning Electron Microscope (SEM) (e.g. JEOL JSM-IT300LV SEM) after resin embedding and using the SEM integrated ruler to measure the edge-to-edge thickness of the mats.

In some preferred embodiments, suitable for use in a fuel cell or an electrolyser and particularly suitable for use in a fuel cell, the reinforced ion-conducting membrane can have a mean average thickness of less than 20 μm, preferably ≤16 μm, more preferably ≤15 μm, and most preferably ≤12 μm or less. In other preferred embodiments, particularly suitable for use in an electrolyser, the ion-conducting membrane can have a mean average thickness in a range of 40 μm to 150 μm, preferably 50 μm to 100 μm, and more preferably 50 μm to 80 μm. The thickness of the reinforced ion-conducting membrane may be measured using a low force high precision gauge instrument (e.g. VL-50B Litematic™ available from Mitutoyo (UK) Ltd.), which may give a direct reading of the membrane thickness. A motorised spindle is used to take measurement readings with a measuring force of 0.01 N. At least three readings are taken from different locations on the ion-conducting membrane layer (prior to adding catalyst layers) at a temperature of 20° C.±3° C., and relative humidity (RH) of 30-50%.

To form the porous mat, nanofibres are formed, suitably by a spinning technique, onto a suitable substrate or surface. For example, the nanofibres may be formed using electrospinning.

In a first embodiment of a process, shown in FIG. 2, an electrospinning formulation comprises at least one heterocyclic based polymer, a cross-linker and optionally a second polymer together in a suitable solvent, such as an organic solvent, or suitable solvent mix. The solvent can comprise (or consist of) at least one of N-methylpyrrolidone (NMP), dimethylformamide (DMF), dimethylacetamide (DMAc) and/or dimethylsulphoxide (DMSO), suitably DMAc and/or DMSO, and preferably DMAc. The suitable solvent mix can be a homogeneous mixture of two or more solvents. The electrospinning formulation can be a solution or a dispersion. The electrospinning formulation is pushed through a needle using a syringe pump, wherein the needle is maintained at a potential difference with respect to the substrate/surface. The electrospun nanofibres are collected on a substrate (e.g. rotating drum collector) moving translationally and rotationally which is set at some distance from the needle, such as around 10-15 cm from the needle. The fibre morphology is obtained through control of the formulation parameters, such as concentration, whereas mat thickness and uniformity is controlled through deposition time and collector rotation/translation speed. The porous mat is treated to cause the heterocyclic-based polymer and the cross-linker to react. A reactive group on the heterocyclic-based polymer reacts with a reactive group on the cross-linker. This reaction forms a cross-linked polymer comprising heterocyclic-based backbones and linking chains as hereinbefore described. Where the second polymer is present, the second polymer is suitably non-reactive towards the cross-linker during the cross-linking treatment.

The cross-linking treatment can be a thermal treatment or a photo-treatment. The thermal treatment can comprise heating the porous mat to a temperature of at least 80° C., preferably at least 85° C. The photo-treatment can comprise irradiating the porous mat with UV light to initiate the cross-linking reaction. In such cases, the electrospinning formulation can also comprise at least one photoinitiator.

It is not necessary to subject the porous mat to any further processing, for example, any densification processes, such as calendaring, or welding etc.

The cross-linker can be a liquid. The liquid cross-linker is preferably miscible with the solvent. Alternatively, the cross-linker can be a solid. Preferably, the solid cross-linker is soluble in the solvent.

The electrospinning formulation can further comprise the second polymer. In such embodiments, the porous mat of nanofibres can comprise the cross-linked polymer and the second polymer. Preferably, the second polymer is non-reactive towards the cross-linker. That is, the second polymer does not chemically react with the cross-linker during the step of treating the porous mat.

In some embodiments, the method comprises providing a further formulation for electrospinning wherein the further formulation comprises a second polymer. The second polymer is ionically non-conductive. Preferably, the second polymer is non-reactive towards the cross-linker. The method can comprise electrospinning the formulation and the further formulation onto the substrate simultaneously.

The cross-linker can be present in the electrospinning formulation in an amount in the range of and including 1 wt. % to 20 wt. %, preferably 3 wt. % to 15 wt. %. The amount of cross-linker can be within a range defined by any combination of the aforementioned upper and lower limits.

The formulation can comprise the heterocyclic-based polymer and the cross-linker in amounts such that the molar ratio of the reactive groups on the heterocyclic-based polymer to the reactive groups on the cross-linker is in the range of and including 25:1 to 1:2, preferably 20:1 to 1:1, and more preferably 10:1 to 1.5:1. The molar ratio of reactive groups on the heterocyclic-based polymer to reactive groups on the cross-linker can be within a range defined by any combination of the aforementioned limits.

In a second embodiment of a process, shown in FIG. 3, a first electrospinning formulation comprises at least one heterocyclic-based polymer in a suitable solvent, such as an organic solvent, or a suitable solvent mix. The solvent can comprise (or consist of) at least one of N-methylpyrrolidone (NMP), dimethylformamide (DMF), dimethylacetamide (DMAc) and/or dimethylsulphoxide (DMSO), suitably DMAc and/or DMSO, and preferably DMAc. The first electrospinning formulation can be a solution or dispersion. The first electrospinning formulation is pushed through a needle using a syringe pump and applying a high voltage to the needle. The mat of electrospun nanofibres is collected on a substrate (e.g. rotating drum collector) moving translationally and rotationally which is set at some distance from the needle, such as around 10-15 cm from the needle. The fibre morphology is obtained through control of the formulation parameters, such as concentration, whereas mat thickness and uniformity is controlled through deposition time and collector rotation/translation speed.

A second formulation comprises (or consists of) a cross-linker and optionally a solvent. For example, the second formulation can be a liquid cross-linker optionally in a suitable solvent. Alternatively, the second formulation can be a solid cross-linker dissolved in a suitable solvent. The solvent can be an organic solvent, such as dimethylformamide (DMF), dimethylacetamide (DMAc), dimethylsulphoxide (DMSO), methyl isobutyl ketone (MIBK), acetone, benzene, butanol, ethylene glycol, ethanol, methanol, propanol, toluene, water, xylene. Preferably, the second formulation is a solution. The second formulation is impregnated into the mat of electrospun nanofibres. After impregnation, the porous mat is treated to cause the heterocyclic-based polymer and the cross-linker to react, as described in relation to the first embodiment of the process. The heterocyclic-based polymer and the cross-linker can be present in amounts such that the molar ratio of the reactive groups on the heterocyclic-based polymer to the reactive groups on the cross-linker is in the range of and including 25:1 to 1:2, preferably 20:1 to 1:1, and more preferably 10:1 to 1.5:1. The molar ratio of reactive groups on the heterocyclic-based polymer to reactive groups on the cross-linker can be within a range defined by any combination of the aforementioned limits.

It is not necessary to subject the porous mat to any further processing, for example, any densification processes, such as calendaring, or welding etc.

The first formulation can further comprise a second polymer. The second formulation can further comprise a second polymer. In such embodiments, the porous mat of nanofibres can be a mixture of the cross-linked polymer and the second polymer. Preferably, the second polymer is non-reactive towards the cross-linker. That is, the second polymer does not chemically react with the cross-linker during the step of treating the porous mat.

The step of impregnating the porous mat with the second formulation can comprise spraying, electro-spraying, screen printing, rotary screen printing, inkjet printing, brush coating, painting, immersion or dipping, bar coating, pad coating, gravure; gap coating techniques such as knife or doctor blade over roll (whereby the coating is applied to the substrate then passes through a split between the knife and a support roller); slot die (slot, extrusion) coating (whereby the coating is squeezed out by gravity or under pressure via a slot onto the substrate); metering rod application such as with a Meyer bar and gravure coating.

The cross-linked polymer is suitably formed by cross-linking at least one heterocyclic-based polymer comprising basic functional groups with a suitable cross-linker. The heterocyclic-based polymer comprises at least one reactive group for reacting with the cross-linker so as to form the cross-linked polymer. For example, the reactive group can be a nucleophile, such as an amine (e.g. a primary or secondary amine) or an imine. The reactive group can be part of a heterocyclic ring.

Suitable heterocyclic-based polymers, preferably basic heterocyclic polymers, include polybenzimidazoles, poly(pyridine)s, poly(pyrimidine)s, polybenzthiazoles, polyoxadiazoles, polyquinolines, polyquinoxalines, polythiadiazoles, polytriazoles, polybenzoxazoles, polyoxazoles, polythiazoles, polypyrazoles and derivatives thereof. Preferably, the heterocyclic-based polymer is selected from polybenzimidazoles, poly(pyridine)s, poly(pyrimidine)s, polybenzthiazoles, polyoxadiazoles, polyquinolines, polyquinoxalines, polythiadiazoles, polytriazoles, polyoxazoles, polythiazoles, polypyrazoles and derivatives thereof. Suitably, the polymer is a functionalised polyazole or a zwitterionic polyazole, such as a polybenzimidazole, polytriazole, polythiazole and polydithiazole and their derivatives; most suitably a polybenzimidazole.

The cross-linker suitably comprises at least two terminal epoxide groups, preferably at least two terminal glycidyl ether groups.

The cross-linker can have a chemical formula selected from the group consisting of:

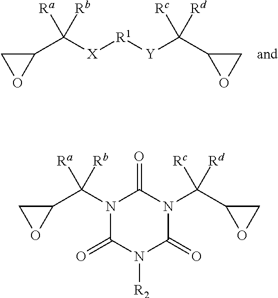

wherein:
R¹ is selected from the group consisting of: an aliphatic C₁₋₁₅ alkyl chain, preferably C₁₋₁₀ alkyl chain and more preferably C₁₋₆ alkyl chain; an alkoxy chain, for example a glycol chain such as [CH₂CH₂O]ₘ, [CH₂CH(CH₃)O]ₘ, [CH₂CH₂CH₂O]ₘ; an aryloxy chain,

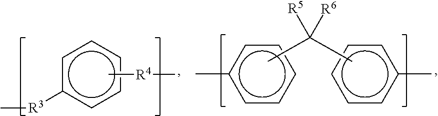

or a combination thereof;
X and Y are each independently selected from the group consisting of: O, [N(R⁷)], [OCH₂CH₂]ₙ, [OCH₂CH(CH₃)]ₙ, [O(CH₂)₃]ₙ and no atom;
R² and R⁷ are each independently selected from the group consisting of: H, C₁₋₅ alkyl chain, and C₁₋₅ alkyl chain in combination with a terminal epoxide group;
m and n are each independently in the range of and including 1 to 225,
R³ and R⁴ are each independently selected from an aliphatic C₁₋₅ alkyl chain; an alkoxy chain, for example a glycol chain; or no atom; and
R^{a}, R^{b}, R^{c}, R^{d}, R⁵ and R⁶ are each independently selected from H, methyl, ethyl, n-propyl, iso-propyl, n-butyl, iso-butyl, sec-butyl, or tert-butyl.

Preferably, X and Y are each independently selected from the group: O and [N(R⁷)]. In some embodiments, X and Y are the same, for example X and Y can both be O. In other embodiments X and Y can both be [N(R⁷)].

Preferably, R² is H or C₁₋₃ alkyl chain in combination with a terminal epoxide group, and more preferably CH₂ in combination with a terminal epoxide group, i.e. [CH₂CHOCH₂].

Preferably, R³ and R⁴ are each independently an aliphatic C₁₋₃ alkyl chain or no atom.

Preferably, R⁵ and R⁶ are each independently selected from H or methyl. In some embodiments, R⁵ and R⁶ are both methyl. In other embodiments, R⁵ and R⁶ are both H.

Preferably, R⁷ is H or C₁₋₃ alkyl chain in combination with a terminal epoxide group, and more preferably CH₂ in combination with a terminal epoxide group, i.e. [CH₂CHOCH₂].

Preferably, R^{a}, R^{b}, R^{c}, R^{d} are each independently H or methyl, and most preferably H.

Preferably, m and n are each independently in the range of and including 1 to 150, more preferably 1 to 130, more preferably 1 to 100 and still more preferably 1-50.

Preferably, the cross-linker can be selected from the group consisting of: 1,4-butanediol diglycidyl ether, neopentyl glycol diglycidyl ether, poly(ethylene glycol) diglycidyl ether, bisphenol A diglycidyl ether, bis[4-(glycidyloxy)phenyl]methane, bisphenol A propoxylate diglycidyl ether, N,N-diglycidyl-4-glycidyloxyaniline, tris(2,3-epoxypropyl) isocyanurate, 1,3-butanediol diglycidyl ether.

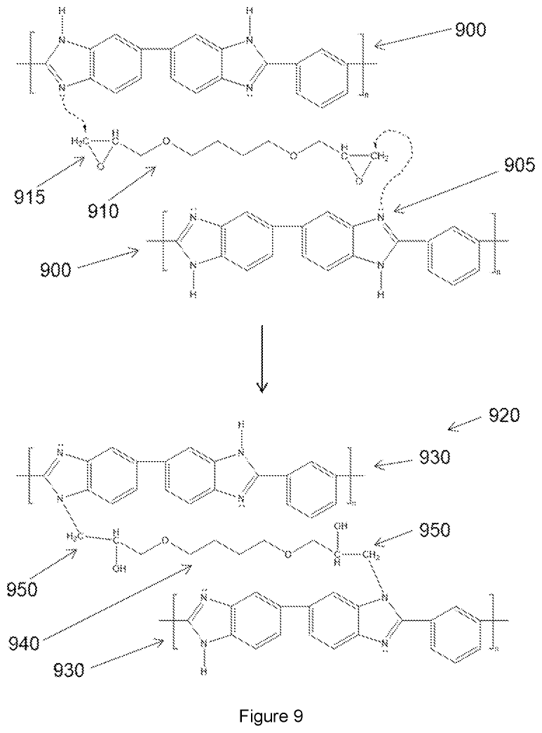

FIG. 9 shows an exemplary cross-linking reaction, in which a heterocyclic-based polymer 900 reacts with a cross-linker 910 to form a cross-linked polymer 920. A reactive group 905 on the heterocyclic-based polymer 900 reacts with a reactive group 915 on the cross-linker 910. In this example the heterocyclic-based polymer 900 is a polybenzimidazole, the cross-linker 910 is 1,4-butanediol diglycidyl ether (BDDGE), and the reactive group on the cross-linker is a terminal epoxide group. The cross-linked polymer 920 comprises heterocyclic-based polymer backbones 930 and linking chains 940, which link two heterocyclic-based polymer backbones 930 via linking groups 950.

The porous mat of nanofibres comprising the cross-linked polymer is subsequently impregnated with an ion-conducting polymer to form a reinforced ion-conducting membrane, such as a reinforced electrolyte membrane. The porous mat of nanofibres can be impregnated with the ion-conducting polymer as part of a roll-to-roll process. Such reinforced ion-conducting membranes have applications as membrane layers in electrochemical devices, such as fuel cells and water electrolysers.

The ion-conducting polymer can be a proton-conducting polymer or an anion-conducting polymer, such as a hydroxyl anion-conducting polymer. Preferably, the ion-conducting polymer is a proton-conducting polymer. Typically, the ion-conducting polymer comprises sulfonic acid groups. Suitably, the ion-conducting polymer is a perfluorinated sulfonic acid ionomer, or a partially-fluorinated or a non-fluorinated hydrocarbon sulfonic acid or phosphoric acid ionomer. Examples of suitable proton-conducting polymers include partially- or fully-fluorinated sulphonic acid polymers, such as perfluorosulphonic acid ionomers (e.g. Nafion® (E.I. DuPont de Nemours and Co.), Aciplex® (Asahi Kasei), Aquivion™ (Solvay Speciality Polymers), Flemion® (Asahi Glass Co.); or ionomers based on a sulphonated hydrocarbon such as those available from FuMA-Tech GmbH as the Fumapem® P, E or K series of products, JSR Corporation, Toyobo Corporation, and others. Examples of suitable anion-conducting polymers include A901 made by Tokuyama Corporation and Fumasep FAA from FuMA-Tech GmbH. Typically, the ion-conducting polymer has an equivalent weight of about 1100 or less, typically about 900 or less, suitably about 850 or less. Typically, the ion-conducting polymer has an equivalent weight of at least about 450. The equivalent weight of the ion-conducting polymer may be readily measured using an acid titration following a hydroxide exchange. For example, a membrane sample may be vacuum dried at about 110° C. for 16 hours to obtain about 2 g of the dried film. The film may then be immersed in about 30 mL of a 0.1N NaOH solution to substitute sodium ions for protons in the membrane. Then titration by neutralisation is carried out, for example using 0.1N hydrochloric acid, to determine the number of exchangeable protons, and therefore the EW may be calculated.

The porous mat is essentially fully impregnated with ion-conducting polymer to form the ion-conducting (electrolyte) membrane. By “essentially fully impregnated” is meant that at least 80%, suitably at least 90%, suitably at least 95% and ideally 100% of the pores of the porous mat are filled with ion-conducting polymer.

Suitably, excess ion-conducting polymer is present on both surfaces of the ion-conducting (electrolyte) membrane to aid adhesion to a catalyst layer.

The porous mat may be impregnated with the ion-conducting polymer by the following process. A layer of ion-conducting polymer (in solution/dispersion) is cast onto a carrier material. While the layer of ion-conducting polymer is still wet, the porous nanofibre mat is laid into the wet layer and the ion-conducting polymer impregnates into one face of the porous mat. A further layer of ion-conducting polymer is applied to a second face of the porous mat and impregnates into the porous mat from the second face. The impregnated porous mat is dried and suitably annealed to form an ion-conducting (electrolyte) membrane.

The solution/dispersion of ion-conducting polymer may comprise additional components, for example short nanofibres, e.g. from 1 to 50 μm.

In the final electrolyte membrane of the invention, the weight ratio of ion-conducting polymer:nanofibres is suitably greater than 70:30 and preferably greater than 90:10. Suitably, the ion-conducting polymer:nanofibres ratio is less than 98:2. In this context, nanofibres refers to the nanofibres in the porous mat.

The thickness of the porous mat in the electrolyte membrane is suitably distributed across at least 50%, suitably 60%, more suitably 70%, more suitably 80%, more suitably at least 85%, and most suitably at least 90%, of the thickness of the final electrolyte membrane. The porous mat extends across the thickness of the membrane, such that the thickness of the electrolyte membrane and the thickness of the porous mat are essentially equal; however, practically, the thickness of the electrolyte membrane may be slightly thicker than that of the porous mat, such that the thickness of the porous mat is at most 99%, such as 95% of the thickness of the electrolyte membrane.

Having the porous mat distributed across at least 80% of the thickness of the electrolyte membrane enhances the stabilisation (mechanical and chemical) of the final electrolyte membrane.

An electrolyte membrane of the invention may comprise more than one porous mat e.g. two porous mats distributed across at least 50% and suitably at least 80% of the thickness of the electrolyte membrane.

The invention also provides a catalysed electrolyte membrane comprising a catalyst layer and an electrolyte membrane of the invention.

The catalyst layer comprises one of more electrocatalysts. The one or more electrocatalysts are independently a finely divided unsupported metal powder, or a supported catalyst wherein small nanoparticles are dispersed on electrically conducting particulate carbon supports. The electrocatalyst metal is suitably selected from
(i) the platinum group metals (platinum, palladium, rhodium, ruthenium, iridium and osmium),
(ii) gold or silver,
(iii) a base metal,
or an alloy or mixture comprising one or more of these metals or their oxides. The preferred electrocatalyst metal is platinum, which may be alloyed with other precious metals or base metals. A base metal is tin or a transition metal which is not a noble metal. A noble metal is a platinum group metal (platinum, palladium, rhodium, ruthenium, iridium or osmium), gold or silver. Suitable base metals include copper, cobalt, nickel, zinc, iron, titanium, molybdenum, vanadium, manganese, niobium, tantalum, chromium and tin. Preferred base metals are nickel, copper, cobalt, and chromium. More preferred base metals are nickel, cobalt and copper. If the electrocatalyst is a supported catalyst, the loading of metal particles on the carbon support material is suitably in the range 10-90 wt %, preferably 15-75 wt % of the weight of resulting electrocatalyst.

The exact electrocatalyst used will depend on the reaction it is intended to catalyse and its selection is within the capability of the skilled person.

The catalyst layer is suitably applied to a first and/or second face of the electrolyte membrane as an ink, either organic or aqueous. The ink may suitably comprise other components, such as ion-conducting polymer as described in EP0731520, which are included to improve the ionic conductivity within the layer. Alternatively, the catalyst layer can be applied by the decal transfer of a previously prepared catalyst layer.

The catalyst layer may further comprise additional components. Such additional components include, but are not limited to, a catalyst which facilitates oxygen evolution and therefore will be of benefit in cell reversal situations and high potential excursions, or a hydrogen peroxide decomposition catalyst. Examples of such catalysts and any other additives suitable for inclusion in the catalyst layer will be known to those skilled in the art.

The invention further provides a membrane electrode assembly comprising an electrolyte membrane of the invention and a gas diffusion electrode on a first and/or second face of the electrolyte membrane.

The invention further provides a membrane electrode assembly comprising a catalysed electrolyte membrane of the invention and a gas diffusion layer or porous transport layer present on the at least one catalyst layers.

The membrane electrode assembly may be made up in a number of ways including, but not limited to:
(i) an ion-conducting (electrolyte) membrane of the invention may be sandwiched between a first gas diffusion electrode or porous transport layer and a second gas diffusion electrode or porous transport layer (one anode and one cathode);
(ii) a catalysed ion-conducting (electrolyte) membrane of the invention having a catalyst layer on one side may be sandwiched between a gas diffusion layer or porous transport layer and a gas diffusion electrode or catalyst-coated porous transport layer, the gas diffusion layer or porous transport layer contacting the side of the catalysed ion-conducting (electrolyte) membrane having the catalyst component or;
(iii) a catalysed ion-conducting (electrolyte) membrane of the invention having a catalyst component on both sides may be sandwiched between a first gas diffusion layer or porous transport layer and a second gas diffusion layer or porous transport layer, e.g. one gas diffusion layer and one porous transport layer.

The anode and cathode gas diffusion layers are suitably based on conventional gas diffusion substrates. Typical substrates include non-woven papers or webs comprising a network of carbon fibres and a thermoset resin binder (e.g. the TGP-H series of carbon fibre paper available from Toray Industries Inc., Japan or the H2315 series available from Freudenberg FCCT KG, Germany, or the Sigracet® series available from SGL Technologies GmbH, Germany or AvCarb® series from Ballard Power Systems Inc., or woven carbon cloths. The carbon paper, web or cloth may be provided with a further treatment prior to being incorporated into a MEA either to make it more wettable (hydrophilic) or more wet-proofed (hydrophobic). The nature of any treatments will depend on the type of fuel cell and the operating conditions that will be used. The substrate can be made more wettable by incorporation of materials such as amorphous carbon blacks via impregnation from liquid suspensions, or can be made more hydrophobic by impregnating the pore structure of the substrate with a colloidal suspension of a polymer such as PTFE or polyfluoroethylenepropylene (FEP), followed by drying and heating above the melting point of the polymer. For applications such as the PEMFC, a microporous layer may also be applied to the gas diffusion substrate on the face that will contact the electrocatalyst layer. The microporous layer typically comprises a mixture of a carbon black and a polymer such as polytetrafluoroethylene (PTFE).

The porous transport layer is suitably based on conventional porous transport substrates, such as a titanium mesh.

The invention further provides an electrochemical device comprising a reinforced ion-conducting membrane (e.g. electrolyte membrane), a catalysed reinforced ion-conducting membrane, or a membrane electrode assembly as hereinbefore described. The electrochemical device can be a fuel cell, such as a proton exchange membrane fuel cell. The electrochemical device can be an electrolyser, such as a water electrolyser.

The invention will be further described with reference to the following examples which are illustrative and not limiting of the invention.

### Examples

Formulations suitable for electrospinning comprising poly[2,2′-(m-phenylene)-5,5′-bibenzimidazole] (PBI), a cross-linker (e.g. 1,4-butanediol diglycidyl ether (BDDGE) or Bisphenol A diglycidyl ether (BADGE)), and/or poly(vinylidene difluoride) (PVDF) were prepared in dimethylacetamide (DMAc) as detailed in Table 1.

TABLE 1

| | PBI/ | Cross-linker | Cross-linker/ | PVDF/ |
|---|---|---|---|---|
| | wt. % | type | wt. % | wt. % |
| Formulation 1 | 18 | BDDGE | 5.5 | — |
| Formulation 2 | 18 | BDDGE | 6.7 | — |
| Formulation 3 | 18 | BDDGE | 7.7 | — |
| Formulation 4 | 13 | BDDGE | 3.6 | 6.5 |
| Formulation 5 | 19 | — | — | — |
| Formulation 6 | 13 | — | — | 6.8 |
| Formulation 7 | 16 | BADGE | 8.6 | — |

The formulations were electrospun onto a substrate using the following parameters: 15 KV applied voltage, 0.15 mL/hr flow rate; needle size of 22 gauge; needle collector distance of 10 cm; drum collector rotation speed of 800 rpm; and translational speed of 10 mm/s. The electrospun mat was removed from the substrate.

To cross-link, the porous mat was thermally treated by holding at a temperature in the range of 85° C. to 120° C. for 1-24 hours until the cross-linking reaction was complete.

Table 2 shows some properties of porous mats made using the formulations. The cross-linked porous mats of all Examples and the porous mats of the Comparative Examples were ionically non-conductive.

TABLE 2

| | | | Ave. | | |
|---|---|---|---|---|---|
| | | | basis | Max. tear | Tear |
| | | Cross- | weight/ | strength/ | index/ |
| | Formulation | linked | g/m² | mN | mN m²/g |
| Example 1 | Formulation 1 | YES | 2.5 | 98 | 39 |
| Example 2 | Formulation 2 | YES | 2.5 | 120 | 48 |
| Example 3 | Formulation 3 | YES | 2.5 | 62 | 25 |
| Example 4 | Formulation 4 | YES | 2.5 | 135 | 54 |
| Example 5 | Formulation 4 | YES | 2.0 | 83 | 42 |
| Example 6 | Formulation 7 | YES | 2.8 | 141 | 50 |
| Comparative | Formulation 1 | NO | 2.5 | 34 | 14 |
| Example 1 | | | | | |
| Comparative | Formulation 2 | NO | 2.5 | 27 | 11 |
| Example 2 | | | | | |
| Comparative | Formulation 3 | NO | 2.5 | 25 | 10 |
| Example 3 | | | | | |
| Comparative | Formulation 5 | NO | 2.5 | 16 | 6 |
| Example 4 | | | | | |
| Comparative | Formulation 6 | NO | 2.5 | 35 | 14 |
| Example 5 | | | | | |

The term “tear index” is used herein to refer to the maximum tear strength (mN) divided by average basis weight (g/m²).

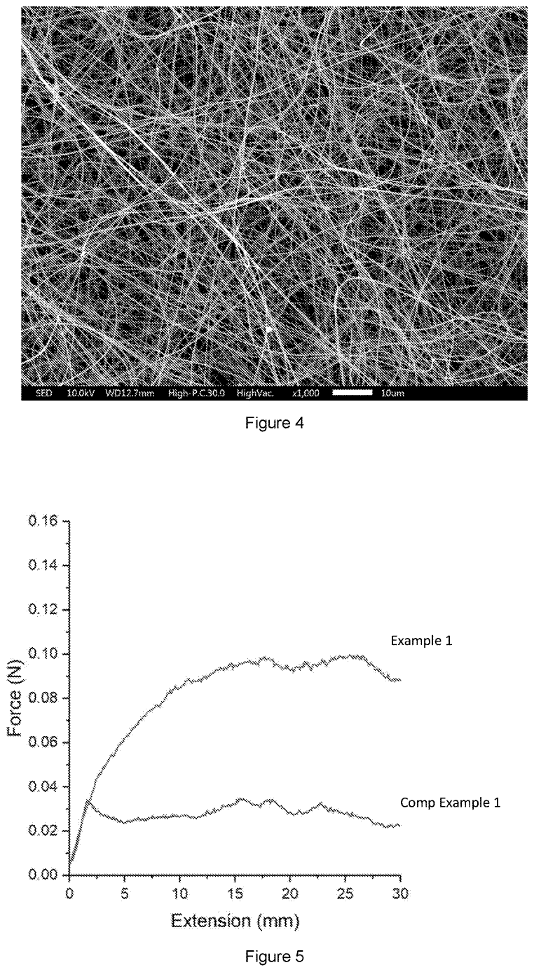

FIG. 4 shows a scanning electron microscope (SEM) image of the electrospun mat of Example 2. The nanofibres cross-over each other and are entangled. The nanofibres are randomly orientated in the xy plane (i.e. in plane direction). The cross-linked electrospun mat comprises nanofibres having a fibre diameter in the range of ˜200-700 nm.

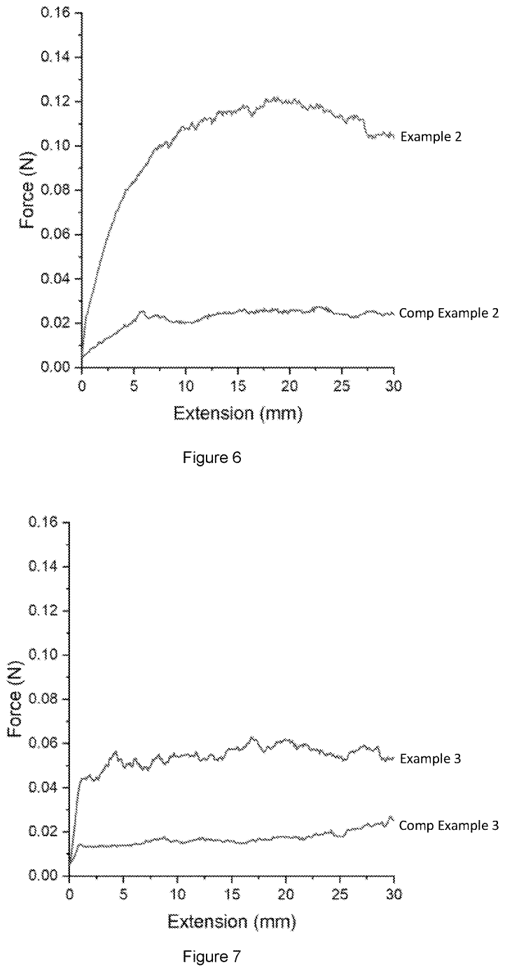

FIGS. 5 to 7 show plots of force (in N) as a function of extension (in mm) before and after performing a cross-linking treatment. In each case, the porous mat had a significantly higher maximum tear strength after the cross-linking treatment. The tear strength can be determined by doing a trouser tear test according to ASTM D1938. In these examples, the test specimens were prepared by cutting 70×30 mm cut-outs from the porous mat. Further, a 25 mm slit was cut from the mid-point of the shorter edge along the central axis to form two tongues. The two tongues were clamped on the grips of a universal mechanical tester attached with a 5 kN load cell and pulled at 50 mm/min crosshead speed. The results were recorded as force (N) vs extension (mm) graphs. The maximum tear strength was recorded at an extension of up to 30 mm.

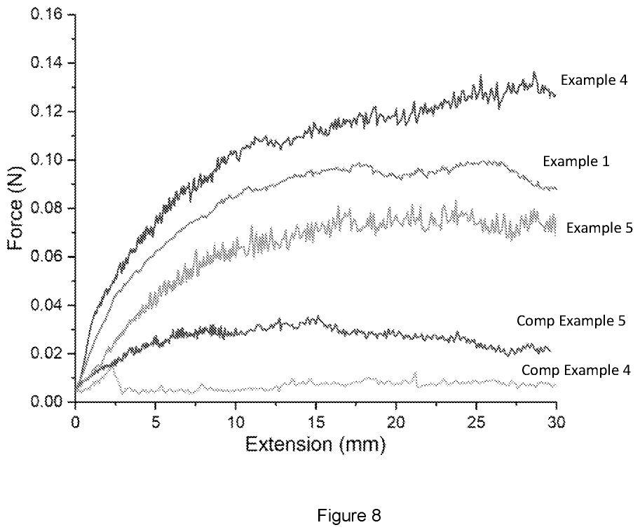

FIG. 8 shows a plot of force (N) as a function of extension (mm) for Examples 2, 5 and 6 and Comparative Examples 4 and 5. Forming a porous mat comprising nanofibres of a cross-linked polymer provided a significant improvement in tear strength compared to Comparative Example 4 (i.e. non-cross-linked PBI mat) and Comparative Example 5 (i.e. mixture of non-cross-linked PBI and PVDF). The combination of including a cross-linked polymer together with a second polymer (e.g. PVDF) provided an unexpectedly significant improvement in maximum tear strength, at comparable basis weights.

After the thermal treatment, the cross-linked porous mats were insoluble in organic solvent, such as dimethylformamide (DMF), N-methylpyrrolidone (NMP), dimethylacetamide (DMAc), and dimethylsulfoxide (DMSO).

Additionally, the contact angle for water on the surface of the cross-linked porous mats of Examples 1-5 was lower after the cross-linking treatment. For example, the contact angles for water measured for Comparative Example 4 and Example 2 were 113° and 99° respectively. The cross-linked porous mats had beneficial properties for facilitating impregnation with an ion-conducting polymer, such as a partially- or fully-fluorinated sulfonic acid ion-conducting polymer. Contact angles were measured using a Drop Shape Analyzer, DSA30 from KRÜSS GmbH and Krüss DSA4 Software. A 6 μL droplet of deionised water was dispensed onto the surface of the nanofibre mats at room temperature (20-25° C.) and 30 images were taken at the frequency of one image per sec. The Krüss DSA4 software was used to determine the drop shape and contact angles.

The porous mat of Example 1 had an ultimate tensile strength of 37 MPa and a strain at break of 49%, when measured in the machine direction; and an ultimate tensile strength of >45 MPa when measured in the transverse direction. The porous mat of Example 3 had an ultimate tensile strength of about 54 MPa and a strain at break of 56%, when measured in the machine direction. The porous mat of Example 3 had an ultimate tensile strength of about 44 MPa and a strain at break of 14%, when measured in the transverse direction. In contrast, Comparative Example 4 had an ultimate tensile strength of 4 MPa and a strain at break of 65-75%, when measured in the machine direction; and an ultimate tensile strength of 15 MPa and a strain at break of 13% when measured in the transverse direction. The mechanical properties of the porous mat of Examples 1 and 3 were more favourable for use as a reinforcing component in a roll to roll manufacturing process than the porous mat of Comparative Example 4.

Impregnation with Ion-Conducting Polymer

The porous mats can be used as reinforcing components as part of a roll-to-roll process for manufacturing a reinforced ion-conducting membrane, in which an ion-conducting polymer impregnates a porous mat. A typical process comprises forming a reinforced ion-conducting membrane by a series of coating passes in which a dispersion of an ion-conducing polymer (e.g. a PFSA ion-conducting polymer) is deposited and then dried before a subsequent coating pass. For example, three coating passes can be used. A porous mat can be introduced into the ion-conducting membrane as part of the second coating pass so that the dispersion of the ion-conducting polymer impregnates the pores of the porous mat. In some embodiments, the process may comprise more or fewer coating passes, e.g. two coating passes, to achieve a reinforced ion-conducting membrane having the same or similar structure.

The porous mats of the present invention have favourable properties for industrial-scale processing, e.g. roll-to-roll processing. The resultant reinforced ion-conducting membrane comprises a reinforced membrane layer (i.e. comprising the porous mat) sandwiched between two unreinforced membrane layers. Such reinforced ion-conducting membranes can have applications as an electrolyte membrane layer in a catalysed reinforced ion-conducting membrane, a membrane electrode assembly, or an electrochemical device, such as a fuel cell and water electrolyser.

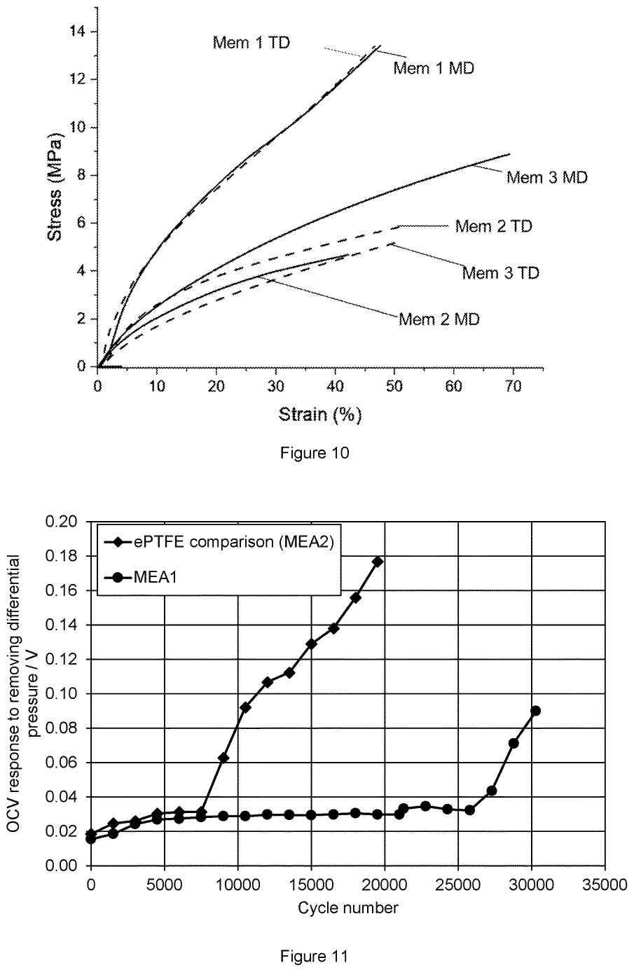

The porous mat of Example 2 was used as a reinforcing component in a roll-to-roll process to make a membrane electrode assembly (MEA1). A dispersion of ion-conducting polymer (3M, EW800) was impregnated into the porous mat and dried to form a reinforced ion-conducting membrane (Mem 1). The thickness of the reinforcing component in the membrane was about 5 μm. The total membrane thickness was about 15 μm. The reinforced ion-conducting membrane (Mem 1) had a secant modulus (at 8% strain) in the machine direction (MD) of 52.2 MPa and a secant modulus (at 8% strain) in the transverse direction (TD) of 52.9 MPa (as shown in FIG. 10). The reinforced ion-conducting membrane of Example 2 (Mem 1) exhibited similar elastic modulus in both machine and transverse directions, indicating a substantially isotropic membrane. For example, the ratio of secant modulus (at 8% strain) in the machine direction to secant modulus (at 8% strain) in the transverse direction was 0.99. As a comparison, a 15 μm thick membrane reinforced using the nanofibre mat of Comparative Example 5 (Mem 2) exhibited a ratio of secant modulus (at 8% strain) in the machine direction to the secant modulus (at 8% strain) in the transverse direction of 0.78 (as shown in FIG. 10). As a further comparison, the ratio of secant modulus (at 8% strain) in the machine direction to the secant modulus (at 8% strain) in the transverse direction of a comparative 15 μm thick reinforced ion-conducting membrane using a known expanded polytetrafluoroethylene (ePTFE) reinforcing component (basis weight 4.7 g/m²) (Mem 3) was 1.5, indicating a higher degree of anisotropy compared with Mem 1 and Mem 2 (as shown in FIG. 10). Moreover, the secant modulus (at 8% strain) in the transverse direction of Mem 1 was 1.85 times higher than the secant modulus (at 8% strain) in the machine direction of the comparative ePTFE-reinforced membrane (Mem 3). As such, the present invention enables thinner reinforcing components (and hence thinner ion-conducting membranes) to be used while still maintaining acceptable mechanical properties, such as tear strength and tensile strength required for industrial processing (e.g. roll-to-roll manufacturing). In turn, it is expected thinner ion-conducting membranes will result in improved ionic conductivity across the membrane and improved cell performance. The secant modulus (at 8% strain) was measured using the method described above.

Mem 1 and Mem 3 were used to manufacture membrane electrode assemblies MEA1 and MEA2 respectively. Catalyst-coated ion-conducting membranes (with an active area of 50 cm²) were prepared by transferring a cathode catalyst layer (50 wt. % Pt/C at a loading of 0.4 mg_{Pt}/cm²) and an anode catalyst layer (60 wt. % Pt/C at a loading of 0.08 mg_{Pt}/cm² and an iridium tantalum oxide oxygen evolution reaction (OER) catalyst) to either side of an ion-conducting membrane (thickness of 15 μm) respectively using a decal transfer process.

A gas diffusion layer (Sigracet 22 BB, commercially available from SGL Carbon) was applied to each face of each catalyst coated ion-conducting membrane to form a membrane electrode assembly (MEA). The gas diffusion layer used was a carbon fibre paper with a hydrophobic microporous layer containing carbon and PTFE applied to the face in contact with the catalyst coated ion-conducting membrane.

### MEA Durability Testing

Durability testing was conducted on a test stand available from Greenlight Innovation in a 50 cm² screener cell. Combined Open Circuit Voltage-RH Cycling (COCV—RH) Accelerated Stress Test:

COCV—RH testing was performed using three general phases: conditioning, diagnostics, and stressing conditions. Cells were conditioned by drawing a current density of 500 mA/cm² at 80° C., 100 kPag on anode and cathode, 100% RH inlet on anode and cathode for 10 hours. After conditioning the diagnostics and stressing conditions phases were alternated until the sample failed.

Diagnostics were carried out at 80° C. and principally included voltage diagnostics which were completed at OCV, 100% RH on anode and cathode, and three pressure conditions of 50 kPag/50 kPag (point 1), 50 kPag/ambient (point 2) and, ambient/ambient (point 3) (anode/cathode).

Stressing conditions were at OCV, 90° C., ambient pressure on anode and cathode, cycling between 0% relative humidity (RH) and 100% RH conditions (1,500 wet/dry cycles per phase) before returning to the diagnostic phase.

The open circuit voltage measured at point 2 subtracted from the open circuit voltage measured at point 3 (in the diagnostics phase) is a parameter that can be used as a proxy for gas crossover. FIG. 11 shows this OCV response to removing the differential pressure (V) as a function of completed wet/dry cycles for MEA 1 and a comparative ePTFE reinforced membrane electrode assembly (MEA2). A part was deemed to have failed when the plot of OCV response to removing differential pressure as a function of completed wet/dry cycles exhibited a sudden change of gradient. MEA1 exhibited significantly improved durability performance during MEA durability testing compared to a conventional ePTFE reinforced membrane (MEA2).

Without wishing to be bound by theory, the inventors believe this may be due to the phase separation and continuity of the electrospun mat and the ionic cross-linking (acid-base interaction, or hydrogen bonding) between the ion-conducting polymer and the surface of the nanofibres in the electrospun web. In addition, the electrospun mat allows greater swelling in the thickness direction as the fibres can move with respect to each other in this direction, but restricts swelling in the in-plane direction as the fibres are not elastic.

Furthermore, the heterocyclic based polymers used to form the electrospun mat have antioxidant properties and can contribute to the stability of the electrolyte membrane by scavenging damaging species such as peroxy free radicals. Due to these antioxidant properties, it may be that it is no longer necessary to incorporate antioxidants or hydrogen peroxide decomposition catalysts, such as ceria, into the membrane.

1. A reinforced ion-conducting membrane comprising:
an ion-conducting polymer; and
a porous mat of nanofibres, which is impregnated with the ion-conducting polymer;
wherein the nanofibres comprise a cross-linked polymer, wherein the cross-linked polymer is ionically non-conductive and comprises:
heterocyclic-based polymer backbones comprising basic functional groups, and
linking chains linking at least two of the heterocyclic-based polymer backbones via linking groups wherein the linking chains have a different chemical structure to the heterocyclic-based polymer backbone;
wherein the porous mat of nanofibres has a tear index of at least 15 mN m²/g.

2. The reinforced ion-conducting membrane according to claim 1, wherein each linking group (A) is independently selected from the group consisting of: 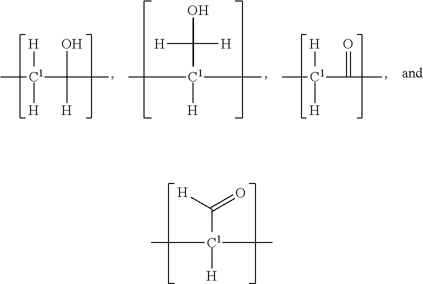
wherein C¹ is chemically bonded to a heterocyclic-based polymer backbone.

3. The reinforced ion-conducting membrane according to claim 1, wherein the linking chains have a chemical formula selected from the group consisting of: 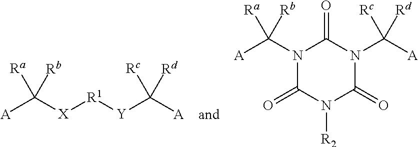
wherein:
A is the linking group, and each linking group A is independently selected from the group consisting of: 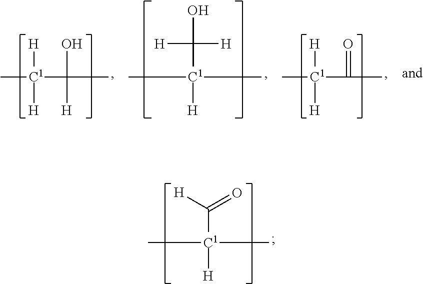
R¹ is selected from the group consisting of: an aliphatic C₁₋₁₅ alkyl chain, preferably C₁₋₁₀ alkyl chain and more preferably C₁₋₆ alkyl chain; an alkoxy chain, for example a glycol chain such as [CH₂CH₂O]ₘ, [CH₂CH(CH₃)O]ₘ, [CH₂CH₂CH₂O]ₘ; an aryloxy chain, 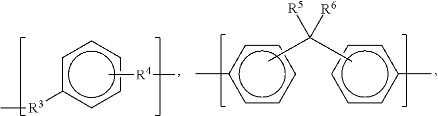
or a combination thereof;
X and Y are each independently selected from the group consisting of: O, [N(R⁷)], [OCH₂CH₂]ₙ, [OCH₂CH(CH₃)]ₙ, [O(CH₂)₃]ₙ and no atom;
R² and R⁷ are each independently selected from the group consisting of: H, C₁₋₅ alkyl chain, and (CH₂)ₚA,
m and n are each independently in the range of and including 1 to 225,
R³ and R⁴ are each independently selected from an aliphatic C₁₋₅ alkyl chain; an alkoxy chain, for example a glycol chain; or no atom;
R^{a}, R^{b}, R^{c}, R^{d}, R⁵ and R⁶ are each independently selected from H, methyl, ethyl, n-propyl, iso-propyl, n-butyl, iso-butyl, sec-butyl, or tert-butyl; and
p is an integer in the range of and including 1 to 5.

4. The reinforced ion-conducting membrane according to claim 2, wherein the linking chains are selected from the group consisting of: 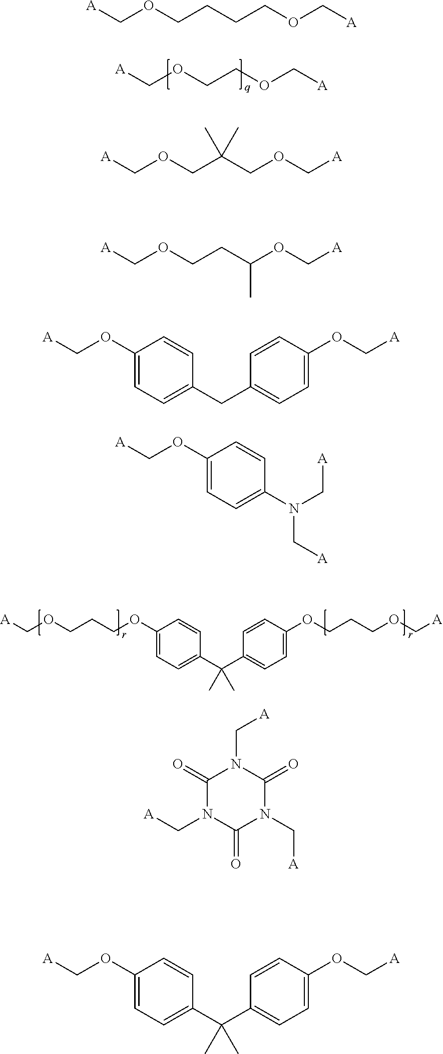
wherein q is in the range of and including 1 to 225, and r is in the range of and including 1 to 225.

5. A reinforced ion-conducting membrane according to claim 1, wherein the linking chains are aliphatic.

6. The reinforced ion-conducting membrane according to claim 5, wherein the linking chains are linear or branched aliphatic chains.

7. The reinforced ion-conducting membrane according to claim 2, wherein C¹ is chemically bonded to a heteroatom of the heterocyclic-based polymer backbone.

8. (canceled)

9. The reinforced ion-conducting membrane according to claim 1, wherein the basic functional groups comprise nitrogen-containing basic functional groups.

10. The reinforced ion-conducting membrane according to claim 1, wherein the heterocyclic-based polymer backbone is selected from the group consisting of: polybenzimidazoles, poly(pyridine)s, poly(pyrimidine)s, polybenzthiazoles, polyoxadiazoles, polyquinolines, polyquinoxalines, polythiadiazoles, polytriazoles, polyoxazoles, polybenzoxazoles, polythiazoles, polypyrazoles and derivatives thereof.

11. The reinforced ion-conducting membrane according to claim 10, wherein the heterocyclic-based polymer backbone is selected from the group consisting of: polybenzimidazoles, polytriazoles, polythiazoles, polydithiazoles and derivatives thereof.

12. The reinforced ion-conducting membrane according to claim 1, wherein the nanofibres are spun nanofibres.

13. A reinforced ion-conducting membrane according to claim 1, wherein the nanofibres further comprise a second polymer, wherein the second polymer is ionically non-conductive and has a different chemical composition to the heterocyclic-based polymer backbone.

14. The reinforced ion-conducting membrane according to claim 13, wherein the second polymer is selected from the group consisting of: polyvinylidene fluoride (PVDF), polytetrafluoroethylene (PTFE), poly(vinylidene fluoride-co-hexafluoropropylene) (PVDF-HFP), polyimides (PI), polyetherimide (PEI), poly(aryl ether ketone) (PAEK), poly(aryl ether sulfone), poly(phenylene sulfide) (PPS), polyvinylpyrrolidone (PVP).

15. The reinforced ion-conducting membrane according to claim 1, wherein the porous mat of nanofibres has an ultimate tensile strength of at least 25 MPa when measured in a machine direction and/or a transverse direction, wherein the machine direction and the transverse direction are perpendicular.

16. The reinforced ion-conducting membrane according to claim 1, wherein the ratio of ultimate tensile strength of the porous mat of nanofibres measured in a machine direction to ultimate tensile strength of the porous mat of nanofibres measured in a transverse direction is in a range of 0.5 to 2, wherein the machine direction and the transverse direction are perpendicular.

17. The reinforced ion-conducting membrane according to claim 1, wherein the porous mat of nanofibres has a strain at break of at least 5%, when measured in a machine direction and/or a transverse direction at a temperature of 20° C.±3° C., a relative humidity of 30-50% and at an extension rate of 20 mm/min, wherein the machine direction and the transverse direction are perpendicular.

18. A reinforced ion-conducting membrane comprising:
an ion-conducting polymer; and
a porous mat of nanofibres, which is impregnated with the ion-conducting polymer;
wherein the nanofibres comprise a cross-linked polymer, wherein the cross-linked polymer is ionically non-conductive and comprises:
heterocyclic-based polymer backbones comprising basic functional groups, and
linking chains linking at least two of the heterocyclic-based polymer backbones via linking groups, wherein the linking chains have a different chemical structure to the heterocyclic-based polymer backbone;
wherein the porous mat has a mean average thickness of 10 μm or less and the reinforced ion-conducting membrane has a secant modulus at 8% strain of at least 30 MPa when measured in a machine direction at 80° C. and 90% RH, and a secant modulus at 8% strain of at least 30 MPa when measured in a transverse direction at 80° C. and 90% RH, wherein the machine direction and the transverse direction are perpendicular.

19. (canceled)

20. (canceled)

21. (canceled)

22. The method of producing a reinforced ion-conducting membrane, the method comprising the steps of:
providing a substrate;
providing a formulation for electrospinning, the formulation comprising a solvent, a cross-linker and a heterocyclic-based polymer comprising basic functional groups,
electrospinning the formulation onto the substrate to form a porous mat of nanofibres;
treating the porous mat to cause the heterocyclic-based polymer and the cross-linker to react thereby forming a cross-linked polymer comprising a heterocyclic-based polymer backbone comprising basic functional groups, and linking chains linking at least two of the heterocyclic-based polymer backbones via linking groups, wherein the linking chains have a different chemical structure to the heterocyclic-based polymer backbone; and
impregnating the porous mat with an ion-conducting polymer.

23. (canceled)

24. (canceled)

25. The method according to claim 22, wherein the formulation further comprises a second polymer, wherein the second polymer is ionically non-conductive; or
wherein the method further comprises the steps of: providing a further formulation for electrospinning, the further formulation comprising a second polymer, wherein the second polymer is ionically non-conductive; and electrospinning the formulation and the further formulation onto the substrate simultaneously.

26. (canceled)

27. (canceled)

28. (canceled)

29. (canceled)

30. (canceled)

31. (canceled)

32. A method according to claim 22, wherein the cross-linker comprises at least two terminal epoxide groups.

33. (canceled)

34. (canceled)

35. (canceled)

36. (canceled)
